(19) United States
(12) Patent Application Publication
(10) Pub. No.: US 2026/0238803 A1
(43) Pub. Date: Aug. 13, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angeles, CA (US); Zhaobin ZHANG, Los Angeles, CA (US); Yaojun WU, Beijing (CN); Meng WANG, Hong Kong (CN); Kai ZHANG, Los Angeles, CA (US); Li ZHANG, Los Angeles, CA (US)

(21) Appl. No.: 19/645,016

(22) Filed: Apr. 10, 2026

Related U.S. Application Data
(63) Continuation of application No. PCT/CN2024/123751, filed on Oct. 9, 2024.

(30) Foreign Application Priority Data
Oct. 10, 2023 (WO) PCT/CN2023/123869

(51) Int. Cl. H04N 19/186; H04N 19/132; H04N 19/136; H04N 19/40

(52) U.S. Cl. CPC H04N 19/186; H04N 19/132; H04N 19/136; H04N 19/40

(57) ABSTRACT

Embodiments of the present disclosure provide a solution for visual data processing. A method for visual data processing is proposed. The method comprises: performing a conversion between visual data and a bitstream of the visual data with a neural network (NN)-based model, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

### CROSS REFERENCE TO RELATED APPLICATIONS

This application is a continuation of International Application No. PCT/CN2024/123751, filed on Oct. 9, 2024, which claims the benefit of International Application No. PCT/CN2023/123869, filed on Oct. 10, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding efficiency of neural network-based image/video coding is generally expected to be further improved.

### SUMMARY

Embodiments of the present disclosure provide a solution for visual data processing.

In a first aspect, a method for visual data processing is proposed. The method comprises: performing a conversion between visual data and a bitstream of the visual data with a neural network (NN)-based model, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

Based on the method in accordance with the first aspect of the present disclosure, the first format for coding the visual data and the second format of output visual data from the conversion are indicated with different indications. Compared with the conventional solution where the first format and the second format are coupled together and controlled by the same syntax element(s). The proposed method can advantageously decouple the signaling of the first and second formats, and thus the first and second formats can be controlled independently. Thereby, the coding flexibility and coding efficiency can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: performing a conversion between the visual data and the bitstream with a neural network (NN)-based model, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

In a fifth aspect, a method for storing a bitstream of visual data is proposed. The method comprises: performing a conversion between the visual data and the bitstream with a neural network (NN)-based model; and storing the bitstream in a non-transitory computer-readable recording medium, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure;

FIG. 1B is a schematic diagram illustrating an example transform coding scheme;

FIG. 2 illustrates example latent representations of an image;

FIG. 3 is a schematic diagram illustrating an example autoencoder implementing a hyperprior model;

FIG. 4 is a schematic diagram illustrating an example combined model configured to jointly optimize a context model along with a hyperprior and the autoencoder;

FIG. 5 illustrates an example encoding process;

FIG. 6 illustrates an example decoding process;

FIG. 7 illustrates an example decoding process according to some embodiments of the present disclosure;

FIG. 8 illustrates an example learning-based image codec architecture;

FIG. 9 illustrates an example synthesis transform for learning based image coding;

FIG. 10 illustrates an example LeakyReLU activation function;

FIG. 11 illustrates an example ReLU activation function;

FIG. 12 illustrates a general JPEG AI decoder structure;

FIG. 13 illustrates a JPEG AI decoder for one component;

FIG. 14 illustrates a synthesis transform net;

FIG. 15 illustrates an example tensor resizing;

FIG. 16 illustrates an example implementation according to some embodiments of the present disclosure;

FIG. 17 illustrates a flowchart of a method for visual data processing in accordance with embodiments of the present disclosure; and

FIG. 18 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

in the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

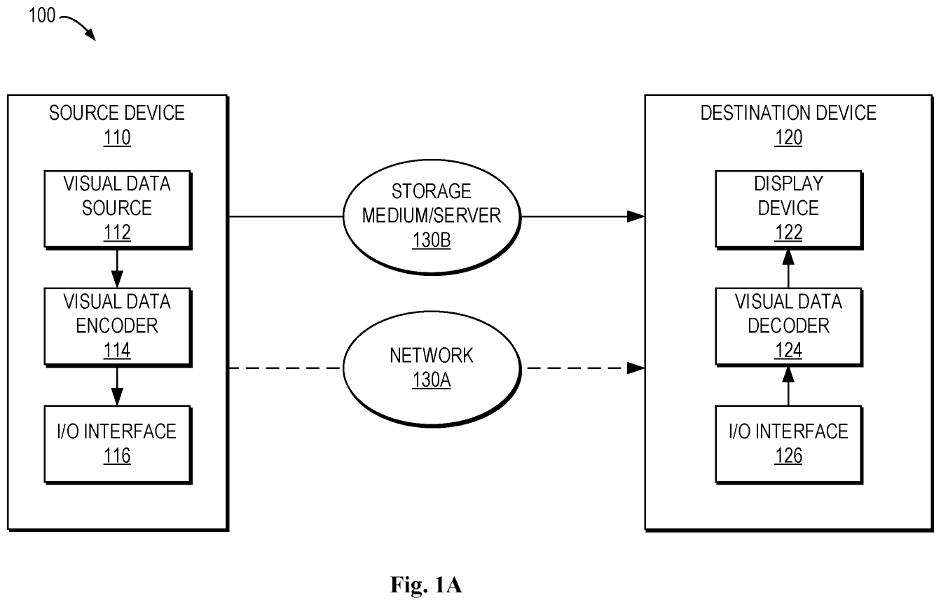

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

The present disclosure is related to neural network (NN)-based image and video coding. Specifically, it is related to support of processing of images with different subsampling ratios. The ideas may be applied individually or in various combinations, for image and/or video coding methods and specifications.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1 Image/Video Compression

Image/video compression (also referred to as image/video coding) usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.
Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.
In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.
Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit −log₂ p(x) without considering the rounding error. Therefore, the remaining problem is to how to determine the probability, which is however very challenging for natural image/video due to the curse of dimensionality.
Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.
It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.
Neural networks were originally introduced for computer vision tasks and have been proven to be effective in regression and classification problems. Therefore, it has been proposed using neural networks to estimate the probability of p(xᵢ) given its context x₁, x₂, . . . , xᵢ₋₁.
Most of the methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks. FIG. 1B is an illustration of atypical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and R with the function gₚ.
It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.
The prototype auto-encoder for image compression is in FIG. 1B, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

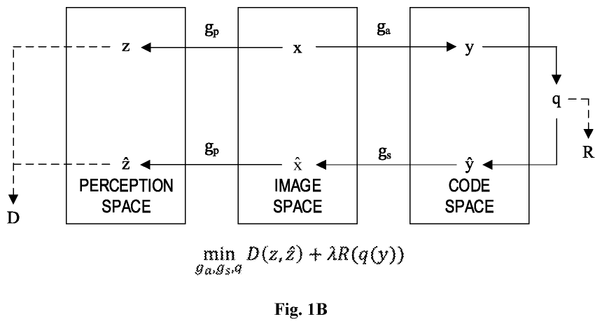

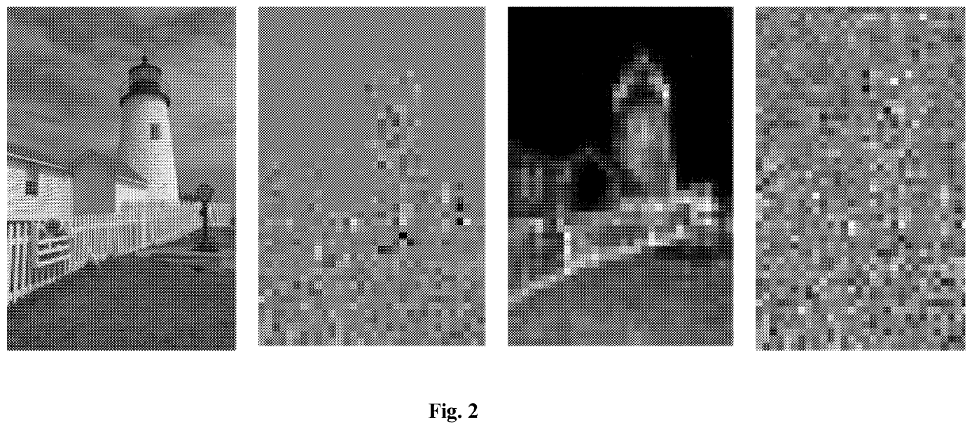

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.
As evident from the middle left and middle right image of FIG. 2, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 3.
In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ŷ into gₛ to obtain the reconstructed image.
When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.
In FIG. 2: Left: an image from the Kodak dataset. Middle left: visualization of a the latent representation y of that image. Middle right: standard deviations σ of the latent. Right: latents y after the hyper prior (hyper encoder and decoder) network is introduced.
FIG. 3 illustrates network architecture of a autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4 Context Model

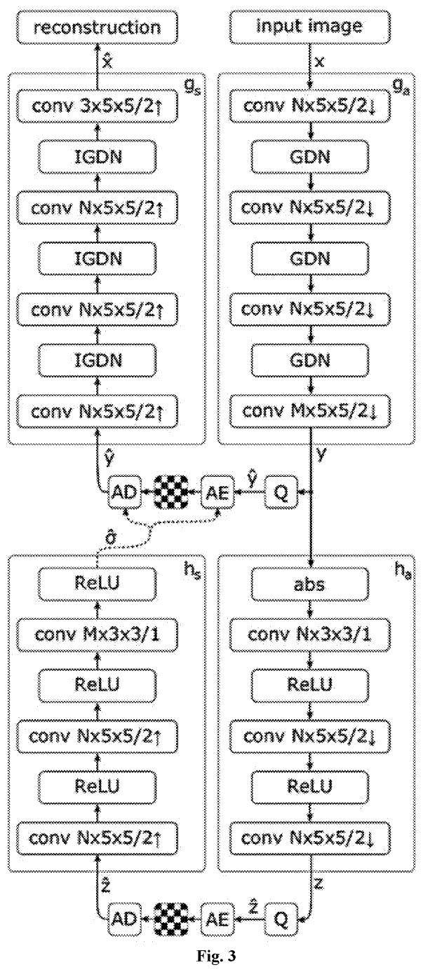

Although the hyper prior model improves the modelling of the probability distribution of the quantized latent y, additional improvement can be obtained by utilizing an autoregressive model that predicts quantized latents from their causal context (Context Model).
The term auto-regressive means that the output of a process is later used as input to it. For example the context model subnetwork generates one sample of a latent, which is later used as input to obtain the next sample.
FIG. 4 is a schematic diagram illustrating an example combined model configured to jointly optimize a context model along with a hyperprior and the autoencoder. The following Table 1 illustrates meaning of different symbols.

TABLE 1
Illustration of symbols

| Component | Symbol |
|---|---|
| Input Image | x |
| Encoder | f(x; θₑ) |
| Latents | y |
| Latents (quantized) | ŷ |
| Decoder | g(ŷ; θ_{d}) |
| Hyper Encoder | fₕ(y; θₕₑ) |
| Hyper-Latents | z |
| Hyper-Latents (quantized) | \hat{z} |
| Hyper Decoder | gₕ(\hat{z}; θ_{hd}) |
| Context Model | g_{cm}(y_{<i}; θ_{cm}) |
| Entropy Parameters | gₑₚ(•; θₑₚ) |
| Reconstruction | \hat{x} |

A joint architecture where both hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.
FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.
Typically the latent samples are modeled as gaussian distribution or gaussian mixture models (not limited to). In an existing design and according to the FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.
The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

where O is channel-wise multiplication, i.e., y̅ₛ₍ᵢ₎=y₍ᵢ₎×αₛ₍ᵢ₎, and αₛ₍ᵢ₎ is the i-th gain value in the gain v_{ector} mₛ. The inverse gain matrix used at the decoder side can be denoted as M′∈R^{c*n}, which consists of n inverse gain vectors, i.e., M′={δₛ₍₀₎, δₛ₍₁₎, . . . , δ_{s(c-1})}, δₛ₍ᵢ₎∈R. The inverse gain process is expressed as

$${y}_{s}^{′} = \hat{y} ⊙ {m}_{s}^{′}$$

where ŷ is the decoded quantized latent representation and

$${y}_{s}^{′}$$

is the inversely gained quantized latent representation, which will be fed into the synthesis network.
To achieve continuous variable rate adjustment, interpolation is used between vectors. Given two pairs of gain vectors

$$\{ {m}_{t} , {m}_{t}^{′} \} and \{ {m}_{r} , {m}_{r}^{′} \} ,$$

the interpolated gain vector can be obtained via the following equations.

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 The Encoding Process Using Joint Auto-Regressive Hyper Prior Model

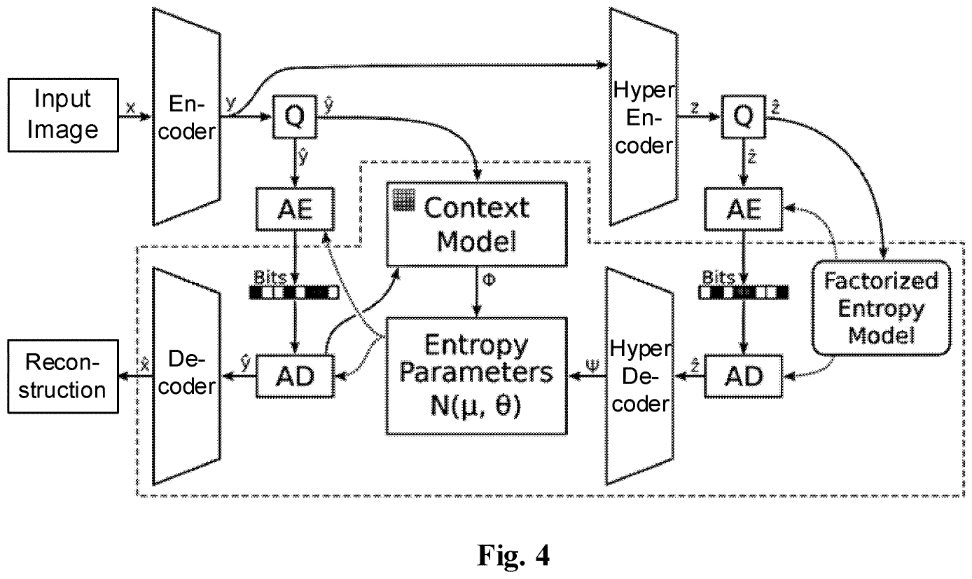

The FIG. 4 corresponds to the state of the art compression method that is proposed. In this section and the next, the encoding and decoding processes will be described separately.
The FIG. 5 depicts the encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.
The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).
The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 n}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In an existing design, the entropy parameters module are used to estimate the mean and the variance values.
The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).
Finally the first and the second bitstream are transmitted to the decoder as result of the encoding process.
It is noted that the other names can be used for the modules described above.
In the above description, the all of the elements in FIG. 5 are collectively called encoder. The analysis transform that converts the input image into latent representation is also called an encoder (or auto-encoder).

### 2.3.7 the Decoding Process Using Joint Auto-Regressive Hyper Prior Model

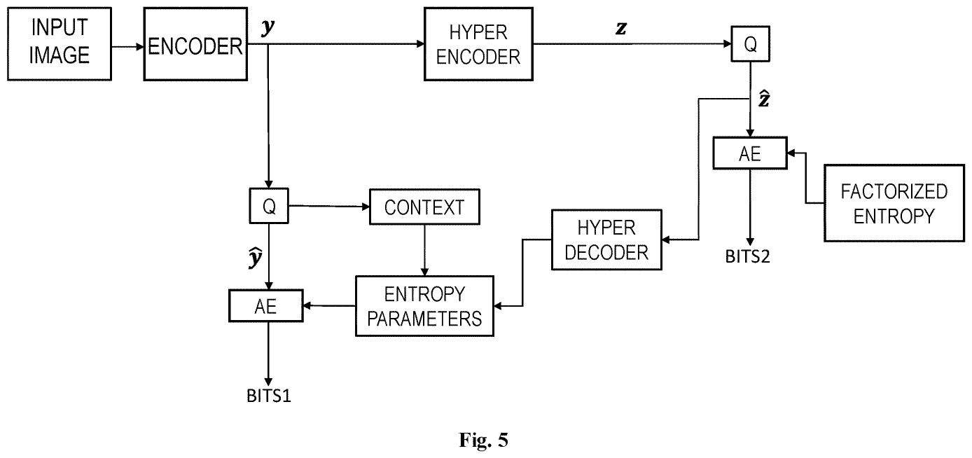

The FIG. 6 depicts the decoding process separately.
In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.
After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder.
After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.
Finally the fully reconstructed quantized latent 9 is input to the synthesis transform (denoted as decoder in FIG. 6) module to obtain the reconstructed image.
In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.
Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] =256=2⁸, thus the pixel can be represented by an 8-bit integer. An uncompressed grayscale digital image has 8 bits-per-pixel (bpp), while compressed bits are definitely less.
A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.
A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.
Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).
To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 2.6 Separate Processing of Luma and Chroma Components of an Image

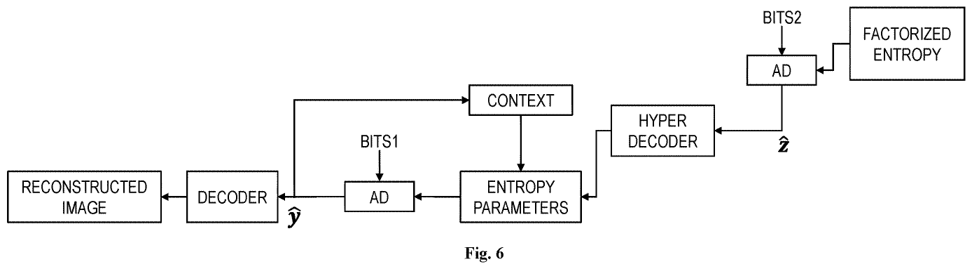

FIG. 7 illustrates the decoding process according to some embodiments of the present disclosure.
According to one implementation, the luma and chroma components of an image can be decoded using separate subnetworks. In FIG. 7, the luma component of the image is processed by the subnetwoks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.
A benefit of the above separate processing is that the computational complexity of the processing of an image is reduced by application of separate processing. Typically in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically the separate processing of luma and chroma components of an image does not result in a prohibitive reduction in performance, as the correlation between the luma and chroma components are typically very small.
The processing (Decoding process) in the above figure can be explained below:
1. Firstly, the factorized entropy model is used to decode the quantized latents for luma and chroma, i.e., \hat{z} and \hat{z}ᵤᵥ in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.
   The module named ICCI is a neural-network based postprocessing module. The present disclosure is not limited to the UCCI subnetwork, any other neural network based postprocessing module might also be used.
   An exemplary implementation of the present disclosure is depicted in the FIG. 7 (the decoding process). The framework comprises two branches for luma and chroma components respectively. In each of the branch, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.
   After the residual latent is obtained, a recursive prediction operation is performed to obtain the latent ŷ and ŷᵤᵥ. The following steps describe how to obtain the samples of latent ŷ[:, i, j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent ŵ[:, i, j] are added together to obtain the latent ŷ[:, i, j].
5. The steps 1-4 are repeated for the next sample.
   Whether to and/or how to apply at least one method disclosed in the document may be signaled from the encoder to the decoder, e.g. in the bitstream.
   Alternatively, whether to and/or how to apply at least one method disclosed in the document may be determined by the decoder based on coding information, such as dimensions, color format, etc.
   Alternative or additionally, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.
   The module named RD or the module named AD in the FIG. 7 might be an entropy decoding module. It might be a range decoder or an arithmetic decoder or the like.
   The proposed solution described herein is not limited to the specific combination of the units exemplified in FIG. 7. Some of the modules might be missing and some of the modules might be displaced in processing order. Also additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the proposed solution is not affected by the removing of one or more of the said scaling and adding modules.
   In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.
   Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.
   Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

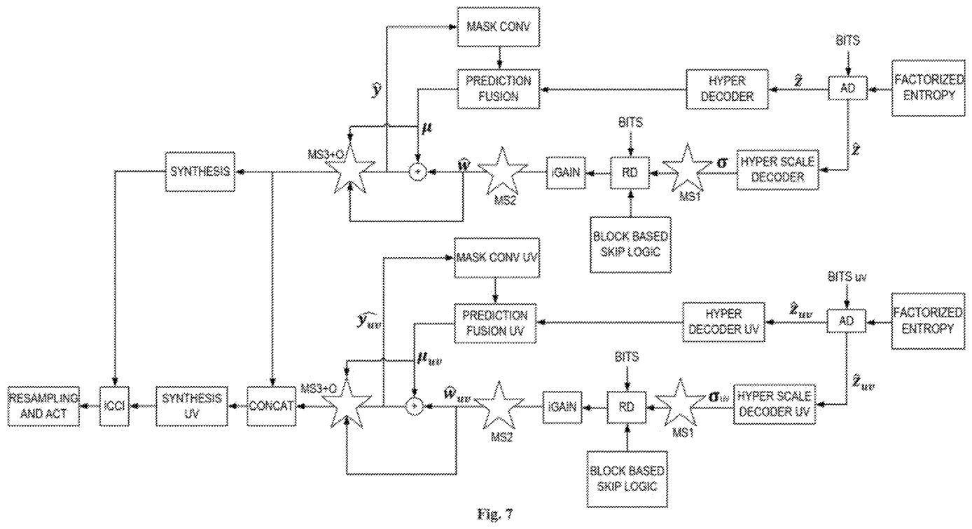

In one example the primary and secondary color components of an image are coded separately, using networks with similar architecture, but different number of channels as shown in 8. All boxes with same names are subnetworks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.
The input signal to be encoded is notated as x, latent space tensor in bottleneck of variational auto-encoder is y. Subscript “Y” indicates primary component, subscript “UV” is used for concatenated secondary components, there are chroma components.
FIG. 8 illustrates learning-based image codec architecture.
First the input image that has RGB color format is converted to primary (Y) and secondary components(UV). The primary component x_{y} is coded independently from secondary components x_{UV} and the coded picture size is equal to input/decoded picture size. The secondary components are coded conditionally, using x_{y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s⬇” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s⬆” on FIG. 8), which outputs secondary components up-sampled with factor s.
The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50% x 50%=25% less samples, therefore it is computationally less complex.

### 2.8 Cropping Operation in Neural Network Based Coding

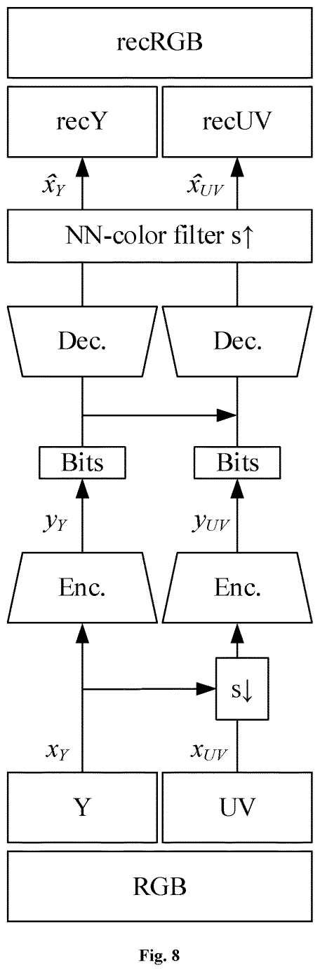

FIG. 9 illustrates synthesis transform example for learning based image coding.
The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.
The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.
For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.
Based on the above explanation, the operation of the cropping layers depend on the output size H,W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/2¹); w₁=2·ceil(W/2¹), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x, n), where n is an integer number. If n is greater than 0, it corresponds to right-shift operator (>>), which moves the bits of of the input to the right, and the left-shift operator (<<), which moves the bits to the left. In another words the bitshift(x, n) operation corresponds to:

$$bitshift ( x , n ) = x * {2}^{n} , or \\ bitshift ( x , n ) = fIoor ( x * {2}^{n} ) , or \\ bitshift ( x , n ) = x / / {2}^{n}$$

The output of the bitshift operation is an integer value. In some implementations, the floor( ) function might be added to the definition.
Floor(x) is equal to the largest integer less than or equal to x.
The “//” operator or the integer division operator: It is an operation that comprises division and truncation of the result toward zero. For example, 7/4 and −7/−4 are truncated to 1 and −7/4 and 7/−4 are truncated to −1.

$$rightshift ( x , n ) = x >> n or \\ leftshift ( x , n ) = x << n$$

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution is a fairly simple operation at heart: you start with a kernel, which is simply a small matrix of weights. This kernel “slides” over the input data, performing an elementwise multiplication with the part of the input it is currently on, and then summing up the results into a single output pixel. In some cases the convolution operation might comprise a “bias”, which is added to the output of the elementwise multiplication operation.
The convolution operation might be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

wherein w1 are the multiplication factors, K1 is called a bias (an additive term) and Iₖ is the k^{th} input, and N is the kernel size in one direction and P is the kernel size in another direction. The convolution layer might consist of convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1 \\ out 2 [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. Wherein the k is the input number, I[1, x, y] is one input and I[2, x, y] is a second input.
The w1, or w describe weights of the convolution operation.

### 2.11 Leaky_Relu Activation Function

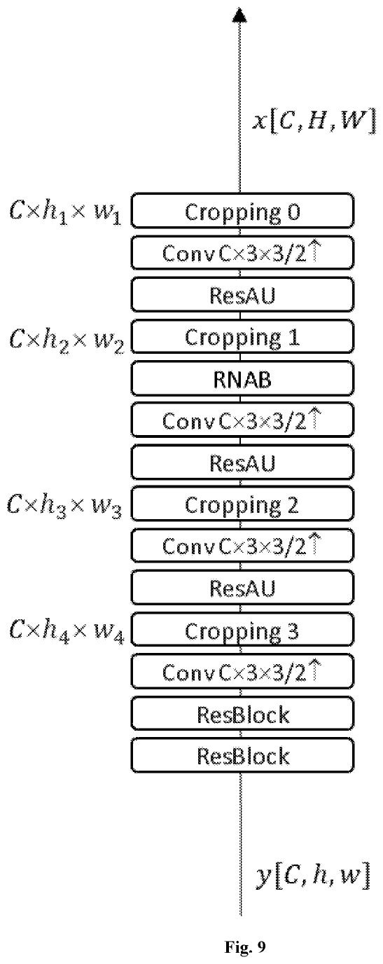

FIG. 10 illustrates Leaky Relu activation function.
The leaky relu activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky relu function.

### 2.12Relu Activation Function

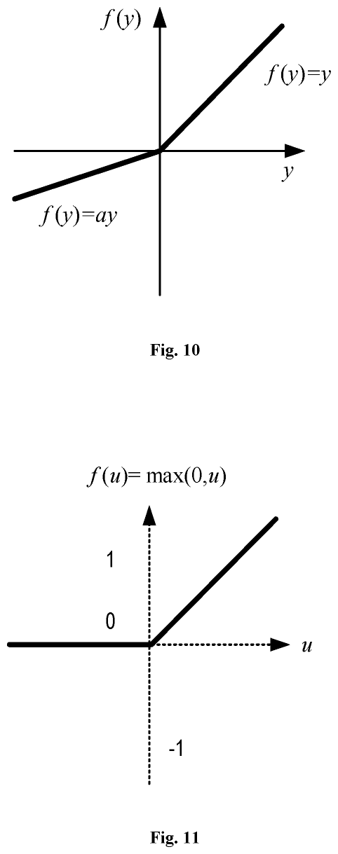

The relu activation function is depicted in FIG. 11. According to the function, if the input is a positive value, the output is equal to the input. If the input (y) is a negative value, the output is equal to 0.

### 2.13 the JPEG AI Image Coding Standard

The design in the latest JPEG AI draft specification utilizes some NN-based image coding methods described mentioned above. Some of the features in the latest JPEG AI specification are described or summarized below.

### 2.13.1 Bitstream Structure

The structure of a JPEG AI bitstream (also referred to as code stream or codestream) is composed of six parts with byte boundary, which are:
1) Start Of Codestream (SOC) marker;
2) Picture header;
3) Codestream of hyper tensor z, including \hat{z}_{Y} and \hat{z}_{UV};
4) Codestream of primary component residual, which includes \hat{r}_{Y};
5) Codestream of secondary component residual, which includes \hat{r}_{UV};
6) End Of Codestream (EOC) marker.
   The overall syntax structure of an image is:

| | Descriptor |
|---|---|
| picture( ) { | |
| SOC | u(16) |
| picture_header( ) | |
| z_stream( ) | |
| r_primary_stream( ) | |
| r_secondary_stream( ) | |
| EOC | u(16) |
| } | |

### 2.13.2 Picture Header

This sub-stream contains information about image height H, width W, latent space tiles location and sizes, control flags for each tool, scaling factors for primary and secondary component, modelIdx—learnable model index and displacement for rate control parameters (β_Y for primary and β_UV for secondary component).
The syntax and semantics are as follows:

| | Descriptor |
|---|---|
| picture_header( ) { | |
| PIH | u(16) |
| picture_header_size | u(16) |
| img_width | u(16) |
| img_height | u(16) |
| picture_format | u(2) |
| bit_depth | u(1) |
| res_changer_header( ) | |
| icc_profile_header( ) | |
| model_header( ) | |
| EFE_upsampler_parameters ( ) | |
| ICCI_header( ) | |
| EFE_nonlinear_filter_parameters ( ) | |
| LEF parameters( ) | |
| } | |

picture_header_size is the number of bytes in the picture header excluding the first two-byte marker;
img_width plus 64 specifies width of an input picture (from 64 to 65600);
img_height plus 64 specifies height of the input picture (from 64 to 65600);
picture_format is a data format of the output picture (YUV420=0, YUV444=1, sRGB=2, YUV444=3);
bit_depth is a bit-depth the output picture (“0” corresponds to 8 and “1” corresponds to 10);
. . .
tile_signaling_type is a type of signalling tiling information. When not present, the value of tile_signaling_type is inferred to be equal to 0.
tile_enable_Luma and tile_enable_Chroma are enable flags for tiling of primary and secondary components.
tile_size_Luma and tile_size_Chroma are size of tiles for primary and secondary components.
tile_overlap_Luma and tile_overlap_Luma are sizes of tiles overlapping areas for primary and secondary components.

| | Descriptor |
|---|---|
| color_transform_header( ) { | |
| color_transform_enable | u(1) |
| if( color_transform_enable ) | |
| for ( i=0;i<3;i++ ) | |
| for ( j=0;j<3;j++ ) | |
| color_transform_matrix[i][j] | u(8) |
| for ( i=0;i<3;i++ ) | |
| color_transform_offset[i] | u(8) |
| } | |

color_transform_enable is an enable fag or color convertion module.
color_transform_matrix[i][j] is a matrix of color convertion. If not present (color_transform_enable is false) then default ITU-R BT.709 colour transform is used (refer to section 7.8).
color_transform_offset[i] is an offset for color transformation If not present (color_transform_enable is false) then default ITU-R BT.709 colour transform is used (refer to section 7.8).

### Decoder Side Colour Transform

If output image color space is RGB then reconstruction process is concluded by inverse colour transform. The input of this process are three colour planes Ŷ[H, W], Û[H, W], \hat{V}[H, W]. The output of this process is reconstructed image in a form of three colour plane tensor [symbol] [3, H, W]. The inverse colour transform in performed for each pixel with coordinates [i, j], 0≤i<H, 0≤j<W. Default colour transform is the same as it is used in ITU-R BT.709. Transformed value is clipped to the diapason specified by out-put bit-depth b:

$$\{ \begin{matrix}\hat{R} [ i , j ] = clip ( 0 , {2}^{b} - 1 , ( \hat{Y} [ i , j ] + 1 \text{.5748} \cdot ( \hat{V} [ i , j ] - 0.5 ) ) \cdot {2}^{b} ) , \\ \hat{G} [ i , j ] = clip ( 0 , {2}^{b} - 1 , ( \hat{Y} [ i , j ] - ( \hat{U} [ i , j ] - 0.5 ) \cdot \frac{0 \text{.0722} \cdot 1.8556}{0.7152} - ( \hat{V} [ i , j ] - 0.5 ) \cdot \frac{0 \text{.2126} \cdot 1.5748}{0.7152} ) \cdot {2}^{b} ) , \\ \hat{B} [ i , j ] = clip ( 0 , {2}^{b} - 1 , ( \hat{Y} [ i , j ] + 1.855 6. ( \hat{U} [ i , j ] - 0.5 ) ) \cdot {2}^{b} ) .\end{matrix}$$

If color_transform_enable is True then non-default colour transform is used:

$$\{ \begin{matrix}\hat{R} [ i , j ] = clip ( 0 , {2}^{b} - 1 , ( \hat{Y} [ i , j ] \cdot a [ 0 ] [ 0 ] + \hat{U} [ i , j ] \cdot a [ 0 ] [ 1 ] + \hat{V} [ i , j ] \cdot a [ 0 ] [ 2 ] + b [ 0 ] ) \cdot {2}^{b - 16} ) , \\ \hat{G} [ i , j ] = clip ( 0 , {2}^{b} - 1 , ( \hat{Y} [ i , j ] \cdot a [ 1 ] [ 0 ] + \hat{U} [ i , j ] \cdot a [ 1 ] [ 1 ] + \hat{V} [ i , j ] \cdot a [ 1 ] [ 2 ] + b [ 1 ] ) \cdot {2}^{b - 16} ) , \\ \hat{B} [ i , j ] = clip ( 0 , {2}^{b} - 1 , ( \hat{Y} [ i , j ] \cdot a [ 2 ] [ 0 ] + \hat{U} [ i , j ] \cdot a [ 2 ] [ 1 ] + \hat{V} [ i , j ] \cdot a [ 2 ] [ 2 ] + b [ 2 ] ) \cdot {2}^{b - 16} ) .\end{matrix}$$

where matrix a [3][3] is equal color_transform_matrix[3][3](signalled in picture header) and vector b[3] is equal to color_transform_offset[3] (color_transform_header in section 9.3).
An image is typically composed of 3 color planes. Red, Green and Blue planes are an example. The operation of color transform is performed to map the image color space to the operating color space of the codec. A typical example of internal operating color space is YUV for codecs. YUV might indicate Y′ component (luma) and two chroma components U and V.

### Chroma Subsampling

4:4:4, 4:2:2, 4:2:0 indicate chroma subsampling. Chroma subsampling is a type of compression that reduces the color information in a signal in favor of luminance data. This reduces bandwidth without significantly affecting picture quality. A video signal is split into two different aspects: luminance information and color information. Luminance, or luma for short, defines most of the picture since contrast is what forms the shapes that you see on the screen. For example, a black and white image will not look less detailed than a color picture. Color information, chrominance, or simply chroma is important as well, but has less visual impact. What chroma subsampling does is reduce the amount of color information in the signal to allow more luminance data instead. This allows you to maintain picture clarity while effectively reducing the file size up to 50%. In the YUV format, luma is only ⅓rd of the signal, so reducing the amount of chroma data helps a lot. Because of bandwidth limitations from internet speeds and HDMI, this makes for much more efficient use of current systems.
A bit shift moves each digit in a number's binary representation left or right. There are three main types of shifts:
The left shift operator is usually written as “<<”.

$$0010 << 1 \to 0100 \\ 0010 << 2 \to 1000$$

A single left shift multiplies a binary number by 2:

$$0010 << 1 \to 0100 \\ 0010 is 2 \\ 0100 is 4$$

### Resolution Changer Syntax

| | Descriptor |
|---|---|
| res_changer_header( ) { | |
| res_changer_enable | u(1) |
| if ( res_changer_enable ){ | |
| for (dim=0; dim < 2; ++ dim){ | |
| scale_comp[dim] | u(1) |
| } | |
| } | |
| } | |

res_changer_enable is an enable flag for resolution changer tool.
scale_comp[2] are vertical and horizontal ratio between primary and secondary components sizes of coded picture sᵥₑᵣ=scale_comp[0] and sₕₒᵣ=scale_comp[1]; if not present (res_changer_enable=false) then sᵥₑᵣ=2 and sₕₒᵣ=2. Allowed values are listed in Table 3.

Descriptor

```
skip_mode_header( ) {
  for (comp=0; comp < 2; ++ comp){
      s_ver=( comp == 0 )? 1: scale_comp[0]
      s_hor=( comp == 0 )? 1: scale_comp[1]
      h4= ceil(ceil(img_height/ s_ver)/(2\hat{ }4))
      w4= ceil(ceil(img_width/ s_hor)/(2\hat{ }4))
      cube_flag_header (h4, w4, comp)
    }
}
```

### Functional Overview on the Decoding Process

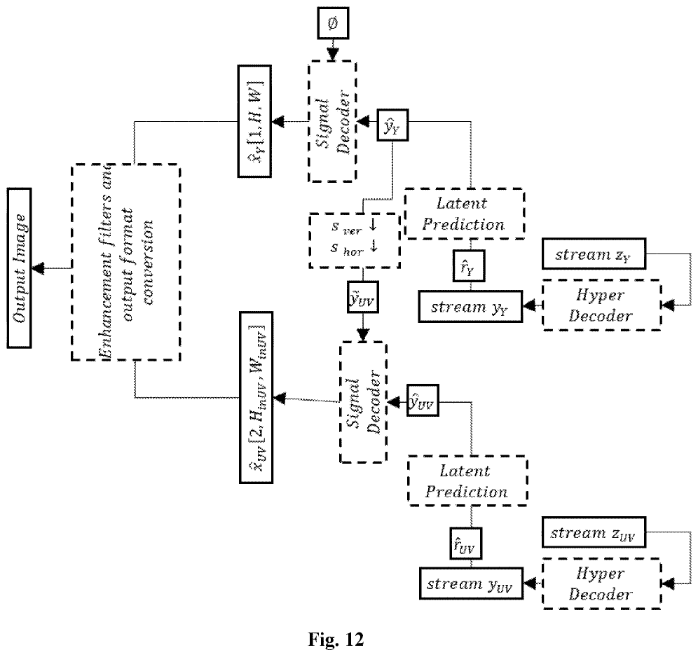

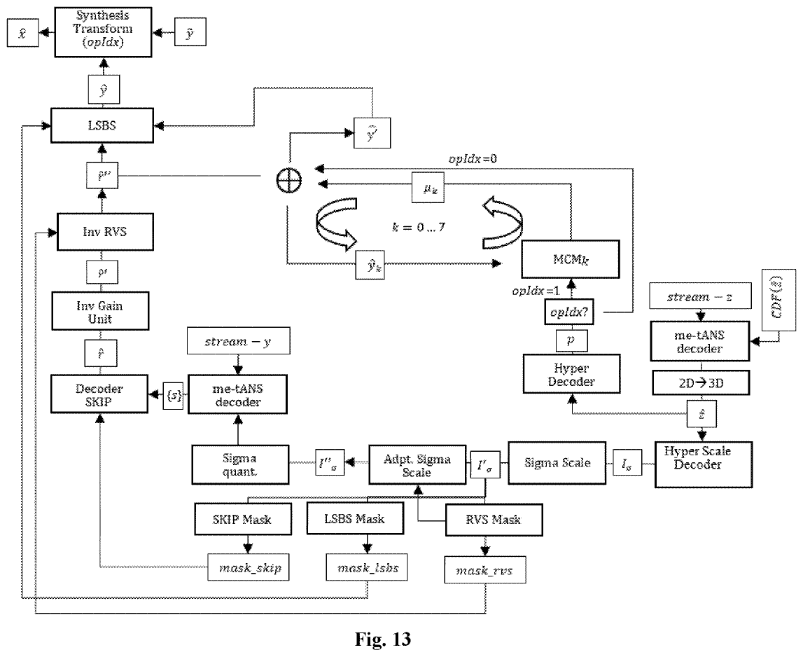

This document specifies the JPEG AI image decoding algorithm.
The overall decoder architecture in shown in FIG. 12. Data (tensors and streams) are shown inside the boxes with solid lines, neural network modules necessary for decoding are shown in boxes with dashed lines, switchable tools are shown in shadowed boxes.
For primary and secondary colour components code streams can be parsed independently and reconstructed using modules consisting of same sequence of same neural-network layers, with the only difference in sizes on input tensors and number of tensor channels. Single component decoder is shown in FIG. 13.
First stream z shall be parsed by loss-less entropy decoder (me-tANS decoder). The probability distribution for loss-less coding of 2 is assumed to be Gaussian with pre-trained parameters (part of the trained model), Commulative Distribution Function (denoted on a FIG. 13 as CDF (2)) computed based on those pre-trained parameters is used in loss-less entropy decoder.
Decoded hyper-prior tensors \hat{z} is used as an input for two different processes: Hyper Decoder (section 11.2) and Hyper Scale Decoder (section 10.3).
Then stream y shall be parsed by loss-less decoder (me-tANS decoder). The probability distribution for parsing \hat{r} is assumed to be Gaussian with zero mean value and standard deviation given as an output if following steps: Hyper Scale Decoder (section 10.3) outputs tensors of standard deviation in log-domain I_{σ}[C, h₄, w₄], then it is scaled according to the rate control parameter β inside Sigma Scale (section 10.4) to produce as I′_{σ}, and then masked and scaled according to RVS parameters section (section 13.2) inside
Adaptive Sigma Scale (section 10.5) producing I″_{σ}. Finally tensor I″_{σ} values are quantized (converted to the index of probability distribution table) in (section 10.8). According to the rules, specified by SKIP Mode (section 13.3) some elements of residual tensor are skipped (not encoded/decoded) and replaced by zeros in Decoder SKIP module (section 13.3.4), which receives parsed set of syntax elements {s} from tANS Decoder (section 9.5), mask_sigma from SKIP Mask generation module (section 13.3.2) and outputs re-shaped to 3D shape reconstructed residual tensor \hat{r}[C, h₄, w₄].
At decoder side the residual \hat{r} is scaled by Inverse Gain Unit (section 12.4) according to the parameter β, producing \hat{r}′. Then residual tensor is scaled in invRVS (Inverse Residual and Variance Scale) module (section13.2.3) forming residual tensor \hat{r}″. This is used for reconstructed latent tensor ŷ.
Hyper decoder (section 11.2) generates explicit_prediction input to Multi-stage Context Model-MCM(section 11.3), which which is eight stages neural network process, which also takes reconstructed residual \hat{r}″ as an input and outputs latent space tensors ŷ′. After Latent Scaling Before Synthesis-LSBS (section 13.4.2) reconstructed latent space tensor ŷ is ready for signal reconstruction. Latent tensors reconstructions for primary and secondary components are independent from each other.
Reconstructed latent space tensors ŷ[C, h₄, w₄] is an input of Synthesis Transform (section Annex B). Another input of Synthesis transform is auxiliary tensor \tilde{y}[C_{d}, h₄, w₄]. For secondary component Synthesis the auxiliary tensor is generated from primary component reconstructed latent tensor. For primary component no auxiliary tensor is used. Depending on input picture height H and width W and scaling factors for primary (s_{Y}) and secondary (s_{UV}) components sizes of tensors are shown in Table 2. For primary component the parameter C_{d}=0. This means that primary component's Synthesis transform receives no auxiliary information (reconstructed independently). For secondary component C_{d}=160, the auxiliary for secondary transform synthesis is \tilde{y}_{Y}, which is re-sampled by integer factor s_{UV}/s_{Y} (using nearest neighbour down-sampling or nearest neighbour up-sampling) reconstructed latent space tensor of primary component ŷ_{Y}.

TABLE 2
Tensor size parameters for primary
and secondary components decoding.

| | Primary “Y” | Secondary “UV” |
|---|---|---|
| | component | component |
| Hᵢₙ | H | ceil(H/sᵥₑᵣ) |
| Wᵢₙ | W | ceil(W/sₕₒᵣ) |
| Cᵢₙ | 1 | 2 |
| h_{d}, d = 0, . . . ,6 | ceil(Hᵢₙ/2^{d}) | ceil(Hᵢₙ/2^{(d<4)?d:d-1}) |
| w_{d}, d = 0, . . . ,6 | ceil(Wᵢₙ/2^{d}) | ceil(Wᵢₙ/2^{(d<4)?d:d-1}) |
| C | Cₚ = 160 | Cₛ = 32 |
| C₃ | 96 + 32 * opIdx | 64 |
| C₂ = C₁ | 64 + 64 * opIdx | 64 |
| C_{d} | 0 | 160 |

Synthesis transform for primary and secondary component consists of same neural network layers, the only difference is the size of input tensor and number of tensor channels. Synthesis transform operations are described in Annex B. Synthesis transform outputs tensor \hat{x}[Cᵢₙ, Hᵢₙ, Wᵢₙ] (tensor sizes are listed in Table 2). As shown on FIG. 12 after synthesis transform primary and secondary components go to the Enhancement filters and output format conversion processing module, which includes re-sampling, inverse color conversion and set of filter described in Annex H.

### Decoder Side Up-Sampling for Secondary Component

Depending on output picture and ratio between sizes of primary and secondary components in coded picture format up-sampling in vertical (with scaling factor sᵥₑᵣ) or horizontal (with scaling factor sₕₒᵣ) direction for secondary component is performed. Supported combinations of output picture format and corresponding sizes of primary (H_{Y}×W_{Y}) and secondary (H_{UV}×W_{UV}), also component scaling factors are listed in Table 3.

TABLE 3
Supported combinations of output picture
format and scaling factors

| output picture | color sampling | | |
|---|---|---|---|
| color sampling | mode for coded | | |
| mode | picture | sᵥₑᵣ | sₕₒᵣ |
| 4:4:4 | 4:4:4 | 1 | 1 |
| H_{Y} = H_{UV} = H | 4:2:2 | 1 | 2 |
| W_{Y} = W_{UV} = W | 4:2:0 | 2 | 2 |
| 4:2:2 | 4:4:4 | Not applicable | Not applicable |
| H_{Y} = H_{UV} = H | 4:2:2 | 1 | 1 |
| W_{Y} = W; W_{UV} = W/2 | 4:2:0 | 1 | 2 |
| 4:2:0 | 4:4:4 | Not applicable | Not applicable |
| H_{Y} = H; H_{UV} = H/2 | 4:2:2 | Not applicable | Not applicable |
| W_{Y} = W; W_{UV} = W/2 | 4:2:0 | 1 | 1 |

If scaling factor sₕₒᵣ>1 or sᵥₑᵣ>1 then up-sampling is performed for secondary component. By default up-sampling is bi-cubic:
For c=0 . . . 1, i=0, . . . H_{UV}−1, j=0, . . . W_{UV}−1:

$${x}_{UV}^{′} [ c , i , j ] = bi - cubic ( {x}_{UV} [ i , j ] , {s}_{ver} , {s}_{hor} ) .$$

If adaptive upsampler is enabled (EFE_enabled_flag is true) then primary component guided adaptive upsampler (described in section 15) is performed.
If adaptive upsampler is enabled (EFE_enabled_flag is false) then x′_{UV} after bi-cubic up-sampling goes to Inter Channel Correlation Information Filter (section 14.1).

### Synthesis Transform Network

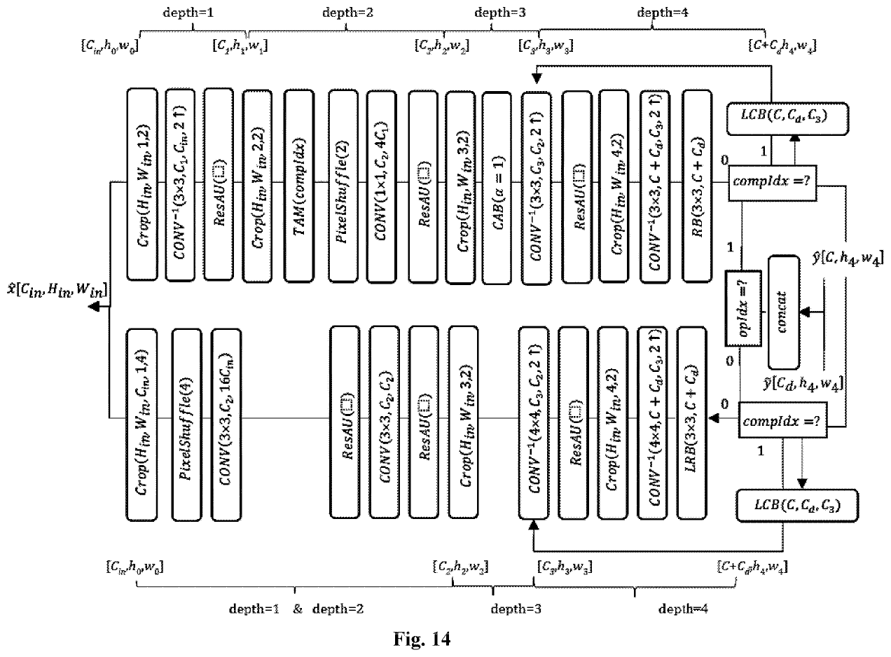

The learning-based reconstruction (called synthesis transform) consists of two pipe-lines (as shown on FIG. 12) with identical neural network architecture, except input size and number of channels.
The input of synthesis transform is
spatial sizes of latent tensor h₄, w₄,
reconstructed latent space tensor ŷ of shape [C, h₄, w₄] concatenated with auxiliary information tensor \tilde{y}[C_{d}, h₄, w₄],
operation point indicator opIdx,
sizes of output tensor Hᵢₙ, Wᵢₙ,
compldx index which specifies component: compldx=0 for primary and compldx=1 for secondary component,
model parameters for Synthesis transform Net defined by pair (modelIdx, opldx, compldx).
   The output of synthesis transform is reconstructed colour component \hat{x} a tensor of size [Cᵢₙ, Hᵢₙ, Wᵢₙ].
   The number of channels for all of those tensors for primary and secondary components are listed in Table 2. In abcense of tiles latent tensor sizes h₄, w₄ and output signal sizes Hᵢₙ, Wᵢₙ are defined in Table 2. In presence of tiles (refer to section 8.4) h₄, w₄ and Hᵢₙ, Wᵢₙ are sizes of corresponding tile.
   The synthesis transform is shown in FIG. 14.
   Synthesis transform starts from concatenation of main latent tensor (ŷ[C, h₄, w₄]) and auxiliary (\tilde{y}[C_{d}, h₄, w₄]) input. The depending on operation point indicator (opIdx) decoder performs following sequence of steps.
   For base operatingpoint (opIdx=0) and primary component (compIdx=0) first step of synthesis transform (depth=4 of deep neural-network process) consists of one light weight residual block with number of channels C+C_{d} is followed by a transposed convolution with kernel size 4×4, which reduces the number of channels to C₃. This transposed convolution is proceeded by cropping layer (stride 2, depth 4) and residual activation unit. For the secondary component (compIdx=1) first step (depth=4) of synthesis stransform is just latent combine block (LCB) which changes number of channels from C+C_{d} to C₃=2 C. The next step (depth=3) for both components is a transposed convolution with kernel size 4×4, which changes the number of channels to C₂. This transposed convolution is proceeded by cropping layer (stride 2, depth 3) and residual activation unit. The next step (depth=2 and 1) of the process is regular convolution with kernel size 3×3, stride 1 and un-changed number of channels C₂ combined with residual activation unit. Then there is a stride 1 convolution 3×3 which increases the number of channels from C₂ to 16Cᵢₙ. This done in order to ensure that the output of the next layer (which is pixel shuffle with stride 4) has the number of channels Cᵢₙ. The process is concluded with cropping layer (stride 4, depth 1).
   For high operating point (opIdx=1) and primary component (compIdx=0) first step of synthesis transform (depth=4 of deep neural-network process) consists of residual block with number of channels C+C_{d}, which is followed by a transposed convolutions with kernel size 4×4, which reduces the number of channels to C₃. This transposed convolution is combined with cropping layer (stride 2, depth 4) and residual activation unit. For the secondary component (compIdx=1) first step of synthesis stransform is just latent combine block (LCB) which changes number of channels from C+C_{d} to C₃. The next step (depth=3) for both components is a transposed convolutions with kernel size 4×4, which changes the number of channels to C₂. Convolution-based attention block is placed the next (it is denoted as CAB on FIG. 14). It is followed by cropping layer (stride 2, depth 3) and residual activation unit.
   The next step (depth=2) of the process is regular convolution with kernel size 1×1, stride 1 and number of output channels is 4C₁. This done in order to ensure that the output of the next layer (which is pixel shuffle with stride 2) has the number of channels C₁. The last step (depth=1) starts with transformer-based attention module (denoted as TAM(compIdx) on FIG. 14), followed by with cropping layer (stride 2, depth 2) and residual activation unit with kernel size 3×3 are performed. The process is concluded by transposed convolutions with kernel size 3×3, stride 2, the number of output channels Cᵢₙ, followed by cropping layer (stride 2, depth 1).

### 3. Problems

The design in the latest JPEG AI draft specification is in JPEG output document WG1N100602 has the following problems:
The color subsampling is a process wherein a first component of an image (e.g. luma component) and/or a second component (e.g. chroma component) might have different sizes (resolutions). Typically the resolution ratio might be 2 to 1, i.e. one component has a size 2 times larger than the second.
In the current JPEG AI draft, the internal processing and output picture subsampling ratios are coupled together and controlled by syntax elements sᵥₑᵣ and sₕₒᵣ. This is exemplified in the above Table 3 (Supported combinations of output picture format and scaling factors). In this table it is specified how “output picture color sampling mode” and “color sampling mode for coded picture” is determined based on the values of sᵥₑᵣ and sₕₒᵣ. It can be seen that the values of sᵥₑᵣ and Sₕₒᵣ are used to determine both the color subsampling of the coded picture (internal subsampling used by the codec) and the output picture subsampling (the picture that is the output of the codec).
FIG. 7 exemplifies a codec structure. In the figure modules like “Synthesis”, “hyper decoder”, “hyper scale decoder”, etc., are responsible for processing of first component of an image. Modules like “Synthesis UV”, “hyper decoder UV”, “hyper scale decoder UV”, etc., are responsible for processing of the second component of an image.
In certain scenarios it is advantageous to use a different sized first and second components in image and video coding. For example the second component might be a chroma component, and might include less information than luma component. Coding the chroma component in reduced resolution might increase coding efficiency and processing efficiency. The samples required to be processed might be lower for the second component.
On the other hand the subsampling ratio (e.g. the size difference between first and second components) of the output picture is typically determined by the application. If the output picture is going to be displayed, the first and second components might be required to be the same size for some displays and different size for some other displays. Also if the output picture is going to be used as a reference picture in a video coding system, it might be desirable to have the second component smaller than the first component.
The requirement for the internal subsampling ratio (used in processing of the samples by the codec) and the output subsampling ratio might be different. In JPEG AI however, the output picture subsampling and internal subsampling cannot be controlled independently.

### 4. Detailed Solutions

An indication signaled in the bitstream may be denoted as a syntax element (SE).
According to some embodiments of the present disclosure:
1. An indication might be included in the bitstream to indicate the internal subsampling ratio and/or the output subsampling ratio.
   An indication is included in the bitstream to indicate the internal subsampling ratio.
   An indication is included in the bitstream to indicate the output subsampling ratio.
   An indication is included in the bitstream to indicate both internal and output subsampling ratio.
   The output subsampling ratio and internal subsampling ratio might be different.
      The output subsampling ratio might not be smaller than the internal subsampling ratio.
         If the internal subsampling ratio is 4:2:0, the output subsampling ratio might be 4:2:0, 4:2:2 and 4:4:4,
         If the internal subsampling ratio is 4:2:2, the output subsampling ratio might be 4:2:2 and 4:4:4,
         If the internal subsampling ratio is 4:4:4, the output subsampling ratio might be 4:4:4.
   The indication determining input subsampling ratio or output subsampling ratio might be included in the bitstream based on a presence flag.
      If the indication is not present in the bitstream a default value might be used.
         The default value might indicate 4:4:4 subsampling or 4:2:0 subsampling.
2. The internal subsampling ratio might control the sizes of tensors during decoding.
   An example of the tensor size determination might be according to a following table. In the table the cᵥₑᵣ and cₕₒᵣ are used to determine the sizes of the tensors during the decoding process:

### Tensor Size Parameters for Primary and Secondary Components Decoding.

| | Primary “Y” | Secondary “UV” |
|---|---|---|
| | component | component |
| Hᵢₙ | H | ceil(H/(3 − cᵥₑᵣ)) |
| Wᵢₙ | W | ceil(W/(3 − cₕₒᵣ)) |
| Cᵢₙ | 1 | 2 |
| h_{d}, d = 0, . . . ,6 | ceil(Hᵢₙ/2^{d}) | ceil(Hᵢₙ/2^{(d<4)?d:d-1}) |
| w_{d}, d = 0, . . . ,6 | ceil(Wᵢₙ/2^{d}) | ceil(Wᵢₙ/2^{(d<4)?d:d-1}) |
| C | Cₚ = 160 | Cₛ = 32 |
| C₃ | 96 + 32 * opIdx | 64 |
| C₂ = C₁ | 64 + 64 * opIdx | 64 |
| C_{d} | 0 | 160 |

3. The output subsampling ratio might control size of the components of the output picture.
   For example an upsampling or resizing operation might be performed to obtain to output picture which might be performed according to the output subsampling ratio.
      The upsampling/resizing operation might be performed according to both internal and output subsampling ratios.
         Might be performed according to the ration between internal and output subsampling ratios.
   An example resizing operation might be as follows, wherein cᵥₑᵣ and cₕₒᵣ specify the internal, sᵥₑᵣ and Sₕₒᵣ specify the output subsampling ratios.

If scaling factor sₕₒᵣ/cₕₒᵣ > 1 or sᵥₑᵣ/cᵥₑᵣ > 1 then up-sampling is performed
for secondary component. By default up-sampling is bi-cubic:
For c = 0 . . . 1, i = 0, . . . H_{UV}-1, j = 0, . . . W_{UV}-1:
x′_{UV}[c, i, j] = bi − cubic (x_{UV}[i, j], sᵥₑᵣ/cᵥₑᵣ, sₕₒᵣ/cₕₒᵣ).

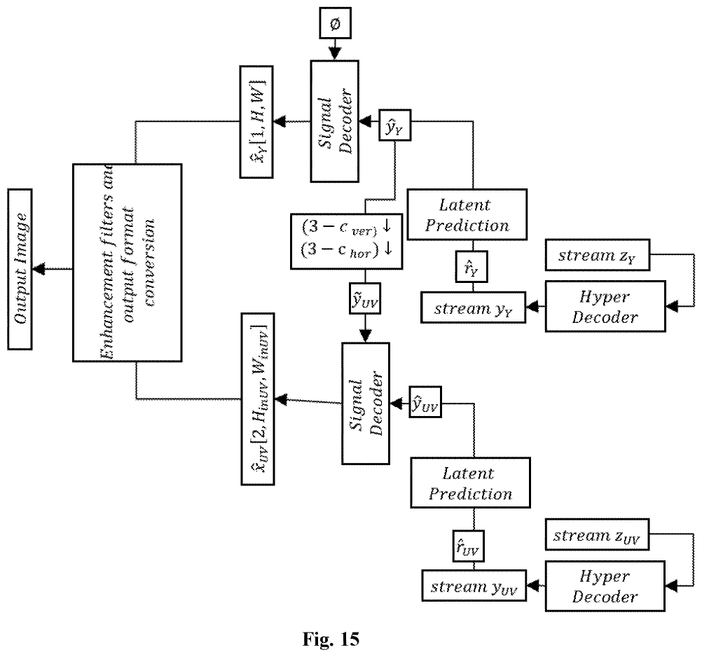

4. The internal subsampling mode or output subsampling mode might be used to determine a tensor resizing operation when decoding.
   The tensor resizing operation might be performed when information exchange between processing of first component and second component is necessary.
   Tensor resizing might be performed by a processing layer of a decoder/encoder.
   The tensor resizing might be an upsampling operation or an interpolation operation or a downsampling operation.
      Nearest sample upsampling or bicubic or bilinear upsampling might be used.
      Nearest sample downsampling or bicubic or bilinear downsampling might be used.
   An example tensor resizing might be depicted in the FIG. 15, wherein of cᵥₑᵣ and cₕₒᵣ indicate the internal subsampling mode.
   The tensor resizing operation might be performed before a synthesis transform or a signal decoder module.
   The tensor resizing operation might be performed before a concatenation of two tensors operation.
      First one of the two tensors might correspond primarily to decoding of a first component of an image.
      Second one of the two tensors might correspond primarily to decoding of a second component of an image.
      Concatenation of the two tensors might be used to obtain the second component of an image.
5. An entropy decoding or an entropy encoding process might be controlled based on internal subsampling ratio or output subsampling ratio.
   The amount of samples to be encoded or decoded might be determined by internal subsampling ratio or output upsampling ratio.
6. An upsampling filter, or a processing layer a codec might be controlled by internal subsampling ratio or output subsampling ratio.
   An adaptive filter might be performed based on internal subsampling ratio or output subsampling ratio.
7. An indication may be signaled to indicate the position of the luma component corresponding to a position of the chroma component.

### General Aspects

8. A syntax element disclosed above may be binarized as a flag, a fixed length code, an EG(x) code, a unary code, a truncated unary code, a truncated binary code, etc. It can be signed or unsigned.
9. A syntax element representing a coding tool or a coding method may not be signalled and implicitly determined to be unused, if the coding tool or the coding method is regarded as not applicable or cannot be used.
10. A syntax element disclosed above may be coded with at least one context model. Or it may be bypass coded.
11. A syntax element disclosed above may be signaled in a conditional way.
   a. The SE is signaled only if the corresponding function is applicable.
   b. The SE is signaled only if the dimensions (width and/or height) of the block satisfy a condition.

### 5. Embodiments

Below are some example embodiments for the detailed solutions aspects summarized above in Section 4.

### Tensor Size Parameters for Primary and Secondary Components Decoding.

| | Primary “Y” | Secondary “UV” |
|---|---|---|
| | component | component |
| Hᵢₙ | H | ceil(H/(3 − cᵥₑᵣ)) |
| Wᵢₙ | W | ceil(W/(3 − cₕₒᵣ)) |
| Cᵢₙ | 1 | 2 |
| h_{d}, d = 0, . . . ,6 | ceil(Hᵢₙ/2^{d}) | ceil(Hᵢₙ/2^{(d<4)?d:d-1}) |
| w_{d}, d = 0, . . . ,6 | ceil(Wᵢₙ/2^{d}) | ceil(Wᵢₙ/2^{(d<4)?d:d-1}) |
| C | Cₚ = 160 | Cₛ = 32 |
| C₃ | 96 + 32 * opIdx | 64 |
| C₂ = C₁ | 64 + 64 * opIdx | 64 |
| C_{d} | 0 | 160 |

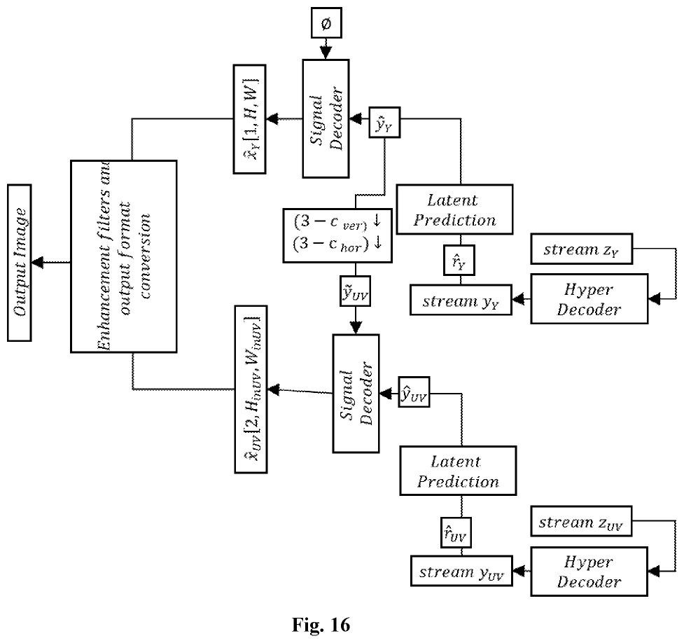

FIG. 16 illustrates an example implementation according to some embodiments of the present disclosure.

### Decoder Side Up-Sampling for Secondary Component

Depending on output picture and ratio between sizes of primary and secondary components in coded picture format up-sampling in vertical (with scaling factor sᵥₑᵣ) or horizontal (with scaling factor sₕₒᵣ) direction for secondary component is performed. Supported combinations of output picture format and corresponding sizes of primary (H_{Y}×W_{Y}) and secondary (H_{UV}×W_{UV}), also component scaling factors are listed in following table 4.

TABLE 4
Supported combinations of output picture format and scaling factors

| output picture | color sampling | | | | |
|---|---|---|---|---|---|
| color sampling | mode for coded | | | | |
| mode | picture | cᵥₑᵣ | cₕₒᵣ | sᵥₑᵣ | sₕₒᵣ |
| 4:4:4 | 4:4:4 | 2 | 2 | 1 | 1 |
| H_{Y} = H_{UV} = H | 4:2:2 | 2 | 1 | 2 | 1 |
| W_{Y} = W_{UV} = W | 4:2:0 | 1 | 1 | 2 | 2 |
| 4:2:2 | 4:4:4 | 2 | 2 | Not applicable | Not applicable |
| H_{Y} = H_{UV} = H | 4:2:2 | 2 | 1 | 1 | 1 |
| W_{Y} = W; W_{UV} = W/2 | 4:2:0 | 1 | 1 | 2 | 1 |
| 4:2:0 | 4:4:4 | 2 | 2 | Not applicable | Not applicable |
| H_{Y} = H; H_{UV} = H/2 | 4:2:2 | 2 | 1 | Not applicable | Not applicable |
| W_{Y} = W; W_{UV} = W/2 | 4:2:0 | 1 | 1 | 1 | 1 |

If scaling factor sₕₒᵣ/cₕₒᵣ>1 or sᵥₑᵣ/cᵥₑᵣ>1 then up-sampling is performed for secondary component. By default up-sampling is bi-cubic:
For c=0 . . . 1, i=0, . . . H_{UV}−1, j=0, . . . W_{UV}−1:

$${x}_{UV}^{′} [ c , i , j ] = bi - cubic ( {x}_{UV} [ i , j ] , {s}_{ν e r} / {c}_{ver} , {s}_{hor} / {c}_{hor} ) .$$

If adaptive upsampler is enabled (EFE_enabled_flag is true) then primary component guided adaptive upsampler (described in section 15) is performed.
If adaptive upsampler is enabled (EFE_enabled_flag is false) then x′_{UV} after bi-cubic up-sampling goes to Inter Channel Correlation Information Filter (section 14.1).

### Resolution Changer Syntax

| | Descriptor |
|---|---|
| res_changer_header( ) { | |
| res_changer_enable | u(1) |
| if ( res_changer_enable ){ | |
| internal_subsampling_mode | u(2) |
| for (dim=0; dim < 2; ++ dim){ | |
| scale_comp[dim] | u(1) |
| } | |
| } | |
| } | |

res_changer_enable is an enable flag for resolution changer tool.
internal_subsmapling_mode identifies the subsampling mode of the chroma component. The variables cᵥₑᵣ and cₕₒᵣ are set according to the following table. The allowable values of cᵥₑᵣ and cₕₒᵣ are specified in Table 4.

| internal_subsampling_mode | cᵥₑᵣ | cₕₒᵣ |
|---|---|---|
| 0 | 1 | 1 |
| 1 | 2 | 2 |
| 2 | 2 | 1 |
| 3 | NA | NA |

scale_comp[2] are vertical and horizontal ratio between primary and secondary components sizes of coded Picture sᵥₑᵣ=scale_comp[0] and sₕₒᵣ=scale_comp[1]; if not present (res_changer_enable=false) then sᵥₑᵣ=2 and sₕₒᵣ=2. Allowed values are listed in Table 4.

Descriptor

```
skip_mode_header( ) {
  for (comp=0; comp < 2; ++ comp){
      h4= ceil(ceil(img_height/ c_ver)/(2\hat{ }4))
      w4= ceil(ceil(img_width/ c_hor)/(2\hat{ }4))
      cube_flag_header (h4, w4, comp)
    }
}
```

### Resolution Changer Syntax

| | Descriptor |
|---|---|
| res_changer_header( ) { | |
| res_changer_enable | u(1) |
| if ( res_changer_enable ){ | |
| internal_subsampling_mode | u(2) |
| output_subsampling_mode | u(2) |
| } | |
| } | |

is an enable flag for resolution changer tool.
internal_subsampling_mode specifies the internal subsampling mode of the chroma component. The variables cᵥₑᵣ and cₕₒᵣ are set according to the following table. The allowable values of cᵥₑᵣ and cₕₒᵣ are specified in Table 4. When not present it's value is inferred to be equal to 0.

| internal_subsampling_mode | cᵥₑᵣ | cₕₒᵣ |
|---|---|---|
| 0 | 1 | 1 |
| 1 | 2 | 2 |
| 2 | 2 | 1 |
| 3 | NA | NA |

output_subsampling_mode specifies vertical and horizontal ratio between primary and secondary components sizes of the output picture. If not present (res_changer_enable=false) then sᵥₑᵣ=2 and sₕₒᵣ=2. Allowed values are listed in Table 4.

| output_subsampling_mode | sᵥₑᵣ | sₕₒᵣ |
|---|---|---|
| 0 | 1 | 1 |
| 1 | 2 | 2 |
| 2 | 2 | 1 |
| 3 | NA | NA |

TABLE 5
Supported combinations of output picture format and scaling factors

| output picture | color sampling | | | | |
|---|---|---|---|---|---|
| color sampling | mode for coded | | | | |
| mode | picture | cᵥₑᵣ | cₕₒᵣ | sᵥₑᵣ | sₕₒᵣ |
| 4:4:4 | 4:4:4 | 2 | 2 | 1 | 1 |
| H_{Y} = H_{UV} = H | 4:2:2 | 2 | 1 | 2 | 1 |
| W_{Y} = W_{UV} = W | 4:2:0 | 1 | 1 | 2 | 2 |
| 4:2:2 | 4:4:4 | 2 | 2 | Not applicable | Not applicable |
| H_{Y} = H_{UV} = H | 4:2:2 | 2 | 1 | 1 | 1 |
| W_{Y} = W; W_{UV} = | 4:2:0 | 1 | 1 | 2 | 1 |
| (W + 1)/2 | | | | | |
| 4:2:0 | 4:4:4 | 2 | 2 | Not applicable | Not applicable |
| H_{Y} = H; H_{UV} = | 4:2:2 | 2 | 1 | Not applicable | Not applicable |
| (H + 1)/2 | | | | | |
| W_{Y} = W; W_{UV} = | 4:2:0 | 1 | 1 | 1 | 1 |
| (W + 1)/2 | | | | | |

More details of the embodiments of the present disclosure will be described below which are related to neural network-based visual data coding. As used herein, the term “visual data” may refer to an image, a picture in a video, or any other visual data suitable to be coded.

As discussed above, in the existing design for neural network (NN)-based visual data coding, the internal processing and output picture subsampling ratios are coupled together and controlled by the same syntax elements sᵥₑᵣ and sₕₒᵣ. Therefore, the coding flexibility decreases.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

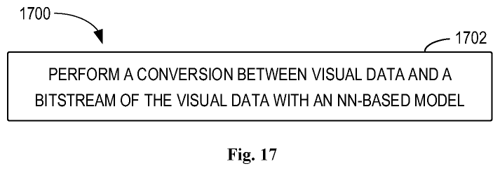

FIG. 17 illustrates a flowchart of a method 1700 for visual data processing in accordance with some embodiments of the present disclosure. At 1702, a conversion between the visual data and a bitstream of the visual data is performed with a neural network (NN)-based model. In some embodiments, the conversion may include encoding the visual data into the bitstream. Additionally or alternatively, the conversion may include decoding the visual data from the bitstream. By way of example rather than limitation, the decoding model shown in FIG. 7 may be employed for decoding the visual data from the bitstream.

As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

In addition, a first format for coding the visual data and a second format of output visual data from the conversion are indicated with different indications. As used herein, the first format for coding the visual data may refer to a format of the output of the entire synthesis transform (which may comprise one or more synthesis transforms) in the NN-based model. This first format for coding the visual data may also be referred to as “internal subsampling ratio”, “coding format”, “coded format”, “coded image format”, “coding mode”, and/or the like. The input of an analysis transform at an encoder side may also be of this first format. It should be noted that this first format is allowed to be different from the second format of output visual data from the conversion (e.g., the output of the entire decoding process). The second format of output visual data from the conversion may also be referred to as “output subsampling ratio”, “output format”, “output image format” and/or the like. It should also be noted that the term “format” may also be referred to as “color format” or the like. Alternatively, the first format may be the same as the second format.

In some embodiments, the first relationship may comprise a ratio between a height of the first component of the coded visual data and a height of the second component of the coded visual data. Additionally or alternatively, the first relationship may comprise a ratio between a width of the first component of the coded visual data and a width of the second component of the coded visual data. By way of example, the bitstream may comprise a first indication and a second indication. The first indication may indicate the ratio between the height of the first component of the coded visual data and the height of the second component of the coded visual data, and the second indication may indicate the ratio between the width of the first component of the coded visual data and the width of the second component of the coded visual data. In some embodiments, the first component may comprise one of the following: a primary component, a luma component, or a Y component, and the second component may comprise one of the following: a secondary component, a chroma component, a U component, or a V component. It should be understood that the above examples are described merely for purpose of description. The scope of the present disclosure is not limited in this respect.

In some embodiments, the second relationship may comprise a ratio between a height of the first component of the output visual data and a height of the second component of the output visual data. Additionally or alternatively, the second relationship may comprise a ratio between a width of the first component of the output visual data and a width of the second component of the output visual data. By way of example, the bitstream may comprise a third indication and a fourth indication. The third indication may indicate the ratio between the height of the first component of the output visual data and the height of the second component of the output visual data, and the fourth indication may indicate the ratio between the width of the first component of the output visual data and the width of the second component of the output visual data.

In view of the above, the first format for coding the visual data and the second format of output visual data from the conversion are indicated with different indications. Compared with the conventional solution where the first format and the second format are coupled together and controlled by the same syntax element(s). The proposed method can advantageously decouple the signaling of the first and second formats, and thus the first and second formats can be controlled independently. Thereby, the coding flexibility and coding efficiency can be improved.

In some embodiments, the first format may be allowed to be different from the second format. By way of example, if the first format is a 4:2:0 format, the second format may be allowed to be one of the following: a 4:4:4 format, the 4:2:0 format, or a 4:2:2 format. If the first format is the 4:2:2 format, the second format may be allowed to be the 4:4:4 format or the 4:2:2 format. If the first format is the 4:4:4 format, the second format may be allowed to be the 4:4:4 format.

In some embodiments, a size of one or more tensors used for coding the visual data may be dependent on the first format. Additionally or alternatively, a size of the second component of the output visual data may be dependent on the second format.

In some embodiments, a resampling operation may be performed on the second component of the visual data in the first format based on the first format and the second format. For example, the second component of the visual data is in the first format (such as 4:2:0 or the like), and a upsampling processing may be applied on the second component based on the first format and the second format (such as 4:4:4 or the like). By way of example rather than limitation, the resampling operation may be performed based on a ratio between the first format and the second format.

In some embodiments, an operation for resizing a tensor may be performed based on at least one of the first format or the second format. For example, the operation may be implemented with a processing layer in the NN-based model. By way of example, the processing layer may be a shuffle layer, which is also known as sub-pixel convolution. Alternatively, the processing layer may be an unshuffle layer. In some still further examples, the operation for resizing the tensor may be an upsampling operation, an interpolation operation, a downsampling operation, or the like. In addition, the operation for resizing the tensor may be performed before a synthesis transform, a signal decoder module, a concatenation of two tensors, and/or the like.

In some embodiments, a filter in the NN-based model may be applied based on at least one of the first format or the second format. For example, the filter may be an enhancement filter which is applied on an output of the synthesis transform or a part of an enhancement filter, such as a non-linear chroma enhancement filter, or the like.

In some embodiments, whether the different indications indicating the first format and the second format are comprised in the bitstream may be dependent on a presence flag. If the different indications are not comprised in the bitstream, a default first format and a default second format may be used.

In some embodiments, an entropy coding process may be performed based on the first format and/or the second format. For example, the number of samples to be encoded or decoded may be determined based on the first format and/or the second format.

In some embodiments, the bitstream may comprise an indication indicating a position of the first component corresponding to a position of the second component.

In some embodiments, any of the above-mentioned indication may be a syntax element. For example, the syntax element may be binarized as one of the following: a flag, a fixed length code, an exponential Golomb (EG) code, a unary code, a truncated unary code, or a truncated binary code. In addition, the syntax element may be coded with at least one context model. Alternatively, the syntax element may be bypass coded. In some embodiments, the syntax element may be signaled based on a condition.

In some embodiments, the syntax element may be indicated at one of the following: a block level, a sequence level, a group of pictures level, a picture level, a slice level, or a tile group level. In some embodiments, the syntax element may be indicated in one of the following: a coding structure of a coding tree unit (CTU), a coding structure of a coding unit (CU), a coding structure of a transform unit (TU), a coding structure of a prediction unit (PU), a coding structure of a coding tree block (CTB), a coding structure of a coding block (CB), a coding structure of a transform block (TB), a coding structure of a prediction block (PB), a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In view of the above, the solutions in accordance with some embodiments of the present disclosure can advantageously improve coding flexibility and coding efficiency.

According to further embodiments of the present disclosure, a non-transitory computer-readable recording medium is provided. The non-transitory computer-readable recording medium stores a bitstream of visual data which is generated by a method performed by an apparatus for visual data processing. The method comprises: performing a conversion between the visual data and the bitstream with a neural network (NN)-based model, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

According to still further embodiments of the present disclosure, a method for storing bitstream of visual data is provided. The method comprises: performing a conversion between the visual data and the bitstream with a neural network (NN)-based model; and storing the bitstream in a non-transitory computer-readable recording medium, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

Implementations of the present disclosure can be described in view of the following clauses, the features of which can be combined in any reasonable manner.

Clause 1. A method for visual data processing, comprising: performing a conversion between visual data and a bitstream of the visual data with a neural network (NN)-based model, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

Clause 2. The method of clause 1, wherein the first relationship comprises at least one of the following: a ratio between a height of the first component of the coded visual data and a height of the second component of the coded visual data, or a ratio between a width of the first component of the coded visual data and a width of the second component of the coded visual data.

Clause 3. The method of clause 2, wherein the bitstream comprises a first indication and a second indication, the first indication indicates the ratio between the height of the first component of the coded visual data and the height of the second component of the coded visual data, and the second indication indicates the ratio between the width of the first component of the coded visual data and the width of the second component of the coded visual data.

Clause 4\hat{z}. The method of any of clauses 1-3, wherein the second relationship comprises at least one of the following: a ratio between a height of the first component of the output visual data and a height of the second component of the output visual data, or a ratio between a width of the first component of the output visual data and a width of the second component of the output visual data.

Clause 5. The method of clause 4, wherein the bitstream comprises a third indication and a fourth indication, the third indication indicates the ratio between the height of the first component of the output visual data and the height of the second component of the output visual data, and the fourth indication indicates the ratio between the width of the first component of the output visual data and the width of the second component of the output visual data.

Clause 6. The method of clauses 1-5, wherein the first format is allowed to be different from the second format.

Clause 7. The method of any of clauses 1-6, wherein if the first format is a 4:2:0 format, the second format is allowed to be one of the following: a 4:4:4 format, the 4:2:0 format, or a 4:2:2 format, or if the first format is the 4:2:2 format, the second format is allowed to be the 4:4:4 format or the 4:2:2 format, or if the first format is the 4:4:4 format, the second format is allowed to be the 4:4:4 format.

Clause 8. The method of any of clauses 1-7, wherein a size of one or more tensors used for coding the visual data is dependent on the first format.

Clause 9. The method of any of clauses 1-8, wherein a size of the second component of the output visual data is dependent on the second format.

Clause 10. The method of any of clauses 1-9, wherein a resampling operation is performed on the second component of the visual data in the first format based on the first format and the second format.

Clause 11. The method of clause 10, wherein the resampling operation is performed based on a ratio between the first format and the second format.

Clause 12. The method of any of clauses 1-11, wherein an operation for resizing a tensor is performed based on at least one of the first format or the second format.

Clause 13. The method of clause 12, wherein the operation is implemented with a processing layer in the NN-based model.

Clause 14. The method of clause 13, wherein the processing layer is a shuffle layer.

Clause 15. The method of any of clauses 1-14, wherein a filter in the NN-based model is applied based on at least one of the first format or the second format.

Clause 16. The method of clause 1, wherein whether the different indications indicating the first format and the second format are comprised in the bitstream is dependent on a presence flag.

Clause 17. The method of clause 12, wherein the operation for resizing the tensor comprises an upsampling operation, an interpolation operation, or a downsampling operation.

Clause 18. The method of clause 12, wherein the operation for resizing the tensor is performed before at least one of the following: a synthesis transform, a signal decoder module, or a concatenation of two tensors.

Clause 19. The method of any of clauses 1-18, wherein an entropy coding process is performed based on at least one of the first format or the second format.

Clause 20. The method of any of clauses 1-19, wherein the bitstream comprises an indication indicating a position of the first component corresponding to a position of the second component.

Clause 21. The method of any of clauses 1-20, wherein the first component comprises one of the following: a primary component, a luma component, or a Y component, and the second component comprises one of the following: a secondary component, a chroma component, a U component, or a V component.

Clause 22. The method of any of clauses 1-21, wherein the visual data comprise a video, a picture of the video, or an image.

Clause 23. The method of any of clauses 1-22, wherein the conversion includes encoding the visual data into the bitstream.

Clause 24. The method of any of clauses 1-22, wherein the conversion includes decoding the visual data from the bitstream.

Clause 25. An apparatus for visual data processing comprising a processor and a non-transitory memory with instructions thereon, wherein the instructions upon execution by the processor, cause the processor to perform a method in accordance with any of clauses 1-24.

Clause 26. A non-transitory computer-readable storage medium storing instructions that cause a processor to perform a method in accordance with any of clauses 1-24.

Clause 27. A non-transitory computer-readable recording medium storing a bitstream of visual data which is generated by a method performed by an apparatus for visual data processing, wherein the method comprises: performing a conversion between the visual data and the bitstream with a neural network (NN)-based model, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

Clause 28. A method for storing a bitstream of visual data, comprising: performing a conversion between the visual data and the bitstream with a neural network (NN)-based model; and storing the bitstream in a non-transitory computer-readable recording medium, wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

### Example Device

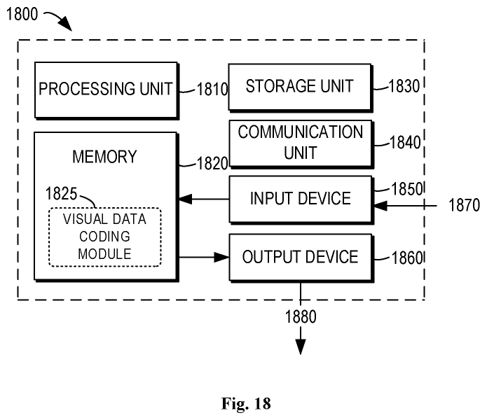

FIG. 18 illustrates a block diagram of a computing device 1800 in which various embodiments of the present disclosure can be implemented. The computing device 1800 may be implemented as or included in the source device 110 (or the visual data encoder 114) or the destination device 120 (or the visual data decoder 124).

It would be appreciated that the computing device 1800 shown in FIG. 18 is merely for purpose of illustration, without suggesting any limitation to the functions and scopes of the embodiments of the present disclosure in any manner.

As shown in FIG. 18, the computing device 1800 includes a general-purpose computing device 1800. The computing device 1800 may at least comprise one or more processors or processing units 1810, a memory 1820, a storage unit 1830, one or more communication units 1840, one or more input devices 1850, and one or more output devices 1860.

In some embodiments, the computing device 1800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1800 can support any type of interface to a user (such as “wearable” circuitry and the like).

The processing unit 1810 may be a physical or virtual processor and can implement various processes based on programs stored in the memory 1820. In a multi-processor system, multiple processing units execute computer executable instructions in parallel so as to improve the parallel processing capability of the computing device 1800. The processing unit 1810 may also be referred to as a central processing unit (CPU), a microprocessor, a controller or a microcontroller.

The computing device 1800 typically includes various computer storage medium. Such medium can be any medium accessible by the computing device 1800, including, but not limited to, volatile and non-volatile medium, or detachable and non-detachable medium. The memory 1820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1830 may be any detachable or non-detachable medium and may include a machine-readable medium such as a memory, flash memory drive, magnetic disk or another other media, which can be used for storing information and/or visual data and can be accessed in the computing device 1800.

The computing device 1800 may further include additional detachable/non-detachable, volatile/non-volatile memory medium. Although not shown in FIG. 18, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 1840 communicates with a further computing device via the communication medium. In addition, the functions of the components in the computing device 1800 can be implemented by a single computing cluster or multiple computing machines that can communicate via communication connections. Therefore, the computing device 1800 can operate in a networked environment using a logical connection with one or more other servers, networked personal computers (PCs) or further general network nodes.

The input device 1850 may be one or more of a variety of input devices, such as a mouse, keyboard, tracking ball, voice-input device, and the like. The output device 1860 may be one or more of a variety of output devices, such as a display, loudspeaker, printer, and the like. By means of the communication unit 1840, the computing device 1800 can further communicate with one or more external devices (not shown) such as the storage devices and display device, with one or more devices enabling the user to interact with the computing device 1800, or any devices (such as a network card, a modem and the like) enabling the computing device 1800 to communicate with one or more other computing devices, if required. Such communication can be performed via input/output (I/O) interfaces (not shown).

In some embodiments, instead of being integrated in a single device, some or all components of the computing device 1800 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1800 may be used to implement visual data encoding/decoding in embodiments of the present disclosure. The memory 1820 may include one or more visual data coding modules 1825 having one or more program instructions. These modules are accessible and executable by the processing unit 1810 to perform the functionalities of the various embodiments described herein.

In the example embodiments of performing visual data encoding, the input device 1850 may receive visual data as an input 1870 to be encoded. The visual data may be processed, for example, by the visual data coding module 1825, to generate an encoded bitstream. The encoded bitstream may be provided via the output device 1860 as an output 1880.

In the example embodiments of performing visual data decoding, the input device 1850 may receive an encoded bitstream as the input 1870. The encoded bitstream may be processed, for example, by the visual data coding module 1825, to generate decoded visual data. The decoded visual data may be provided via the output device 1860 as the output 1880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
performing a conversion between visual data and a bitstream of the visual data with a neural network (NN)-based model,
wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

2. The method of claim 1, wherein the first relationship comprises at least one of the following:
a ratio between a height of the first component of the coded visual data and a height of the second component of the coded visual data, or
a ratio between a width of the first component of the coded visual data and a width of the second component of the coded visual data.

3. The method of claim 2, wherein the bitstream comprises a first indication and a second indication, the first indication indicates the ratio between the height of the first component of the coded visual data and the height of the second component of the coded visual data, and the second indication indicates the ratio between the width of the first component of the coded visual data and the width of the second component of the coded visual data.

4. The method of claim 1, wherein the second relationship comprises at least one of the following:
a ratio between a height of the first component of the output visual data and a height of the second component of the output visual data, or
a ratio between a width of the first component of the output visual data and a width of the second component of the output visual data.

5. The method of claim 4, wherein the bitstream comprises a third indication and a fourth indication, the third indication indicates the ratio between the height of the first component of the output visual data and the height of the second component of the output visual data, and the fourth indication indicates the ratio between the width of the first component of the output visual data and the width of the second component of the output visual data.

6. The method of claim 1, wherein the first format is allowed to be different from the second format.

7. The method of claim 1, wherein if the first format is a 4:2:0 format, the second format is allowed to be one of the following: a 4:4:4 format, the 4:2:0 format, or a 4:2:2 format, or
if the first format is the 4:2:2 format, the second format is allowed to be the 4:4:4 format or the 4:2:2 format, or
if the first format is the 4:4:4 format, the second format is allowed to be the 4:4:4 format.

8. The method of claim 1, wherein a size of one or more tensors used for coding the visual data is dependent on the first format.

9. The method of claim 1, wherein a size of the second component of the output visual data is dependent on the second format.

10. The method of claim 1, wherein a resampling operation is performed on the second component of the visual data in the first format based on the first format and the second format.

11. The method of claim 10, wherein the resampling operation is performed based on a ratio between the first format and the second format.

12. The method of claim 1, wherein an operation for resizing a tensor is performed based on at least one of the first format or the second format.

13. The method of claim 12, wherein the operation is implemented with a processing layer in the NN-based model, and
wherein the processing layer is a shuffle layer.

14. The method of claim 1, wherein a filter in the NN-based model is applied based on at least one of the first format or the second format.

15. The method of claim 1, wherein the first component comprises one of the following: a primary component, a luma component, or a Y component, and the second component comprises one of the following: a secondary component, a chroma component, a U component, or a V component, or
wherein the visual data comprise a video, a picture of the video, or an image.

16. The method of claim 1, wherein the conversion comprises encoding the visual data into the bitstream.

17. The method of claim 1, wherein the conversion comprises decoding the visual data from the bitstream.

18. The method of claim 1, wherein the conversion comprises: generating the bitstream from the visual data, and
the method further comprises: storing the bitstream in a non-transitory computer-readable recording medium.

19. An apparatus for visual data processing comprising a processor and a non-transitory memory with instructions thereon, wherein the instructions upon execution by the processor, cause the processor to perform operations comprising:
performing a conversion between visual data and a bitstream of the visual data with a neural network (NN)-based model,
wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.

20. A non-transitory computer-readable storage medium storing instructions that cause a processor to perform operations comprising:
performing a conversion between visual data and a bitstream of the visual data with a neural network (NN)-based model,
wherein a first format for coding the visual data and a second format of output visual data from the conversion are indicated with different indications, the first format indicates a first relationship between a size of a first component of the coded visual data and a size of a second component of the coded visual data, and the second format indicates a second relationship between a size of a first component of the output visual data and a size of a second component of the output visual data.
